(19) United States
(12) Patent Application Publication
(10) Pub. No.: US 2024/0303561 A1
(43) Pub. Date: Sep. 12, 2024

(54) USING MACHINE LEARNING TO SELECT SERVICE PROVIDER CANDIDATES

(71) Applicant: Admiin Inc. (d.b.a. Paro Inc.), Chicago, IL (US)

(72) Inventors: Saumyendra Mathur, Sugar Land, TX (US); Shitanshu Chandra, Hyderabad (IN)

(21) Appl. No.: 18/118,885

(22) Filed: Mar. 8, 2023

(51) Int. Cl. G06Q 10/0631; G06Q 10/0639

(52) U.S. Cl. CPC G06Q 10/06311; G06Q 10/0639

(57) ABSTRACT

Machine learning is used to determine different relative component score weighting options for different service categories. A specification of a desired service in a specific service category is received. A relative component score weighting among the different relative component score weighting options is identified for the specific service category. A profile of a service provider candidate is analyzed using machine learning to determine at least one component score among a plurality of different component scores for the service provider candidate. A total score is calculated for the plurality of different component scores based on the identified relative component score weighting for the specific service category.

### BACKGROUND OF THE INVENTION

An individual may be tasked with selecting another individual from a group of individuals to perform a task. The individual may implicitly or explicitly introduce their subjective bias into the selection process. For example, the individual may select a first individual from the group merely because the individual has previously worked with the first individual on one or more previous tasks, yet one or more other individuals included in the group may be better qualified to perform the task. As a result, the individual's bias may prevent the one or more other individuals from ever being selected to perform the task.

### BRIEF DESCRIPTION OF THE DRAWINGS

Various embodiments of the invention are disclosed in the following detailed description and the accompanying drawings.

FIG. 1A is a diagram illustrating a system for removing bias when performing a selection operation in accordance with some embodiments.

FIG. 1B is a functional diagram illustrating a programmed computer system for matching one or more service provider candidates to a specification of a desired service in a specific service category in accordance with some embodiments.

FIG. 2 is a flow diagram illustrating a process for removing bias when performing a selection operation in accordance with some embodiments.

FIG. 3 is a flow diagram illustrating a process for retraining a machine learning model in accordance with some embodiments.

FIG. 4 is a flow diagram illustrating a process for determining a component score for a service provider candidate in accordance with some embodiments.

FIG. 5 is an example of a specification of a desired service in a specific service category in accordance with some embodiments.

FIG. 6 is an example of a list of service provider candidate profiles in accordance with some embodiments.

FIG. 7 is an example of a comparison view of service provider candidates in accordance with some embodiments.

FIG. 8 is an example of a total score associated with a service provider candidate in accordance with some embodiments.

FIG. 9 is a diagram illustrating a list of service provider candidates in accordance with some embodiments.

FIG. 10 is an example of feedback screen that is provided in accordance with some embodiments.

FIG. 11 is a diagram illustrating a list of service provider candidates in accordance with some embodiments.

FIG. 12A-12I are examples of an intake form for a specification of a desired service in accordance with some embodiments.

FIG. 13 is an example of a profile of a service provider candidate in accordance with some embodiments.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

A technique to remove bias when performing a selection operation is disclosed. A matching engine may utilize one of a plurality of machine learning models to match one or more service provider candidates to a specification of a desired service in a specific service category associated with a service provider. Using machine learning to determine different relative component score weighting options for different service categories provides an objective way to select service provider candidates for the desired service. It ensures that no one component score is controlling in the selection decision.

Each of the machine learning models is associated with a different service category (e.g., chief financial officer (CFO), full charge bookkeeping, CPA/accounting advisory, FP&A, tax preparation, healthcare, legal, software, consulting, construction, engineering, distribution, education, environment, finance, tourism, etc.). The machine learning models are stored in a storage accessible by the matching engine. Each of the machine learning models is configured to compute a total score that indicates a likelihood that the service provider will select a service provider candidate in the service category for which the machine learning model is trained. The total score is based on a plurality of different component scores. For example, the plurality of different component scores may include a text match score, a software match score, an industry score, a quality score, a pricing score, and/or a skills score.

Each of the different component scores is associated with a relative component score weighting. The relative component score weighting associated with a component score may be based on service category. For example, the skills score may have a first relative component score weighting for a first service category and a second relative component score weighting for a second service category. The total available score may be a value equal to 100 points. A total score associated with a service provider candidate may be a score that is greater than and equal to 0 points and less than and equal to 100 points. Each of the different component scores may be allotted a particular number of points (e.g., 10 points). The different component scores may initially have an equal weight, that is, each of the different component scores are allocated an equal number of points. For example, the text match score, the software match score, the industry score, the quality score, the pricing score, and the skills score may be initially allocated 12.5 points.

The plurality of machine learning models may be trained in a manner that adjusts the relative weight given to a component score based on the service category. The number of points allocated to a particular score may be different. For example, the software match score may be allocated 20 points for a first service category and 15 points for a second service category. In some embodiments, a relative component score weighting for a component score is a multiplier value between 0 and 1. In some embodiments, the matching engine implements a supervised machine learning model (e.g., linear regression) to determine the different relative component weighting score options for different service categories. For example, the machine learning model may determine, for a first service category, to allocate 25 points to a text match score, 15 points to a software match score, 20 points to an industry match score, 15 points to a quality score, 10 points to a pricing score, and 15 points to a skills score. The machine learning model may determine, for a second service category, to allocate 30 points to a text match score, 15 points to a software match score, 15 points to an industry match score, 10 points to a quality score, 10 points to a pricing score, and 20 points to a skills score. Tailoring the relative component weighting scores for different service categories may ensure that the matching engine identifies service provider candidates that are a better match for a specific service category than using a “one size fits all” machine learning model for all of the different service categories.

The plurality of machine learning models may be re-trained in a manner that adjusts the relative weight given to a component score based on feedback received from a service provider and/or a service provider candidate. The relative component score weight for a particular component score may increase or decrease from the initial weight based on feedback received from a service provider. The relative component score weights of the component scores for a service category may be updated each time feedback is received from the service provider. In some embodiments, feedback is received from the service provider after a set of one or more service provider candidates is presented to the service provider. For example, the matching engine may recommend five different service provider candidates and the service provider may select four of the five different service provider candidates. In some embodiments, feedback is received from the service provider after a selected service provider candidate has completed the desired service. For example, the service provider may provide feedback that indicates a quality of work performed by a selected service provider candidate did not meet expectations. In response to such feedback, the points allocated to the quality score may be increased. Re-training a machine learning model may help the matching engine to identify future service provider candidates that a service provider is more likely to select. Re-training the machine learning model may also ensure that the matching engine adapts with changes to services in different categories, that is, the current qualities that a service provider desires in a service provider candidate today may be different than the future qualities that the service provider desires in a service provider candidate.

The matching engine may receive from a service provider a specification of a desired service in a specific service category. The specification of the desired service may include one or more of: a plurality of features, such as a description, a title, a service line, a billing type, a project type, the estimated number of hours for a project, an estimated service provider candidate rate, an estimated start date, an estimated end date, one or more industry tags, one or more software tags, one or more skills tags, call notes, etc.

The matching engine may identify, for the specific service category, a relative component score weighting among the different relative component score weighting options. As discussed above, the relative component score weighting for a particular component score depends on the service category. The matching engine determines, for each component score, the corresponding relative component score weights (e.g., the total number of points allocated to a component score for the service category).

The matching engine is coupled to a database that identifies a plurality of service provider candidates for all service categories. Each potential service provider candidate is associated with one or more service categories. The matching engine filters a set of potential service provider candidates from the plurality of service provider candidates by including in the set of potential service provider candidates one or more service provider candidates having a feature that matches the service category associated with the received specification and excluding from the set of potential service provider candidates one or more service provider candidates not having a feature that matches the service category associated with the received specification. For example, the feature may be an industry tag.

The matching engine is coupled to a database that stores profiles associated with the plurality of service provider candidates. The matching engine may analyze, for each service provider candidate included in the set of potential service provider candidates, a profile of the service provider candidate using machine learning to determine at least one component score among the plurality of different component scores for the service provider candidate.

The profile of the service provider candidate may include a plurality of features, such as one or more skill tags that indicate skill(s) possessed by the service provider candidate, one or more software tags that indicate software with which the service provider candidate is proficient, one or more industry tags that indicate the industry or industries with which the service provider candidate has experience, a quality tag that indicates an estimated quality of work associated with the service provider candidate, an estimated service provider candidate rate, etc. The profile may include one or more free form text sections, such as an “About Me section” that enables the service provider candidate to describe themselves in words.

In some embodiments, the matching engine determines a first component score for the service provider candidate by determining a similarity between the received specification of the desired service and the profile of the service provider candidate. The matching engine may generate a first embedding for the received specification of the desired service by applying one or more sentence transformers to a description portion of specification of the desired service and a second embedding for one or more free form text sections of the profile of the service provider candidate. The first embedding is a vector representation of the text included in the description portion of the specification of the desired service. The second embedding is a vector representation of the text included in the one or more free form text sections of the profile of the service provider candidate.

The one or more sentence transformers are configured to remove extraneous information from the description portion of the specification. The one or more sentence transformers are configured to transform the text included in the description portion of the specification into a better input form for the similarity comparison. The first embedding for the received specification of the desired service may be a different vector representation of the text if the one or more sentence transformers are not applied to the description portion of the desired service specification. As a result, the determined similarity between the first embedding and the second embedding may return a different set of potential service provider candidates than if the one or more sentence transformers are applied to the description portion of the desired service specification. Not applying the one or more sentence transformers to the description portion of the desired service specification may reduce the accuracy of the total score calculated for the service provider candidate by the matching engine (i.e., the likelihood that the service provider will select the service provider candidate) because the first component score for the service provider candidate does not accurate reflect the similarity between the profile of a service provider candidate and the description portion of the desired service specification.

In some embodiments, the matching engine determines the similarity between the first embedding and the second embedding by computing a cosine similarity. The first component score may be allocated a certain number of points (e.g., 30 points). In some embodiments, the matching engine allocates all of the points allocated to the first component score for a cosine similarity value of 1. In some embodiments, the matching engine does not allocate any of the points allocated to the first component score for a cosine similarity value of 0. In some embodiments, the matching engine allocates some of the points allocated to the first component score for a cosine similarity value that is between 0 and 1. The number of points allocated may be scaled based on the cosine similarity value. For example, the number of points allocated to the first component score may be 30 and the cosine similarity value may be 0.5. The matching engine may allocate 15 points to the first component score for the service provider candidate.

The matching engine may allocate points to a component score based on whether a tag included in the received specification matches a tag included in the profile of the service provider candidate. For example, a software match score may be based on whether one or more tags included in the received specification match one or more tags included in the profile of the service provider candidate. The matching engine may divide the points for a component score that is based on tags amongst the one or more tags included in the received specification. For example, 15 points may be allocated to a component score that is based on tags. The received specification may include three tags. The matching engine may allocate five points to each tag. The component score for the service provider candidate may be 0, 5, 10, or 15, depending on whether the profile associated with the service provider candidate includes the tags included in the received specification.

The matching engine may allocate points to a component score for a service provider candidate based on their quality rating. For example, the total number of points allocated to a quality score may be 15 points. In some embodiments, the matching engine allocates 15 points to the service provider candidate for having a platinum rating, 12 points for having a gold rating, 9 points for having a silver rating, and 6 points for having a bronze rating. A service provider candidate's quality score is based on feedback provided by one or more previous services performed by the service provider candidate for one or more other service providers. In some embodiments, a service provider candidate is a new service provider candidate. In such embodiments, the service provider candidate may be allocated a default number of points (e.g., 10 points).

The matching engine may allocate points to a component score based on whether a cost associated with the service provider candidate (e.g., service provider candidate rate ($/hour)×length of project (# of hours, # of weeks, # of months, etc.)) is within an expected budget for the desired service as specified in the specification of the desired service. In some embodiments, a service provider candidate is allocated the full number of points if the cost associated with the service provider candidate is within the expected budget for the desired service. In some embodiments, a service provider candidate is allocated some of the points if the cost associated with the service provider candidate exceeds the expected budget, but less than a first threshold (e.g., a percentage over the expected budget, an amount over the expected budget). In some embodiments, a service provider candidate is allocated none of the points if the cost associated with the service provider candidate exceeds the expected budget and is greater than the first threshold.

The matching engine may calculate a total score for the plurality of different component scores based on the identified relative component score weighting for the specific service category. In some embodiments, the matching engine adds the different component scores to determine the total score. In some embodiments, a weighting value is applied to each of the different component scores. Determining a plurality of different component scores provides an objective way to select one or more service provider candidates.

After determining a corresponding total score for each of the service provider candidates included in the set of potential service provider candidates, the matching engine may compare the potential service provider candidate scores to a threshold score and select one or more service provider candidates having a corresponding total score that is above the threshold score. In some embodiments, the total number of service provider candidates provided to the service provider is limited to a particular number of service provider candidates (e.g., 5). In some embodiments, the matching engine selects to include in a list of service provider candidates one or more experienced potential service candidates (i.e., assigned to a previous service for a different or the same service provider) and one or more new service candidates (i.e., new to the platform).

The matching engine may receive feedback regarding the list of service provider candidate(s) from the service provider. Such feedback may be used to re-train the machine learning model associated with the specific service category. The matching engine may receive from the service provider an approval indication. In response to receiving the approval indication, the matching engine may provide to the service provider candidates included in the list, a proposal to perform the desired service included in the specification.

A response may be received from one of the service provider candidates. The response may include a pitch describing why the service provider candidate is a good fit and should be selected to perform the proposal. Subsequently, the response that includes the pitch is provided to the service provider. The service provider may then decide whether to move forward with the service provider candidate for the desired service.

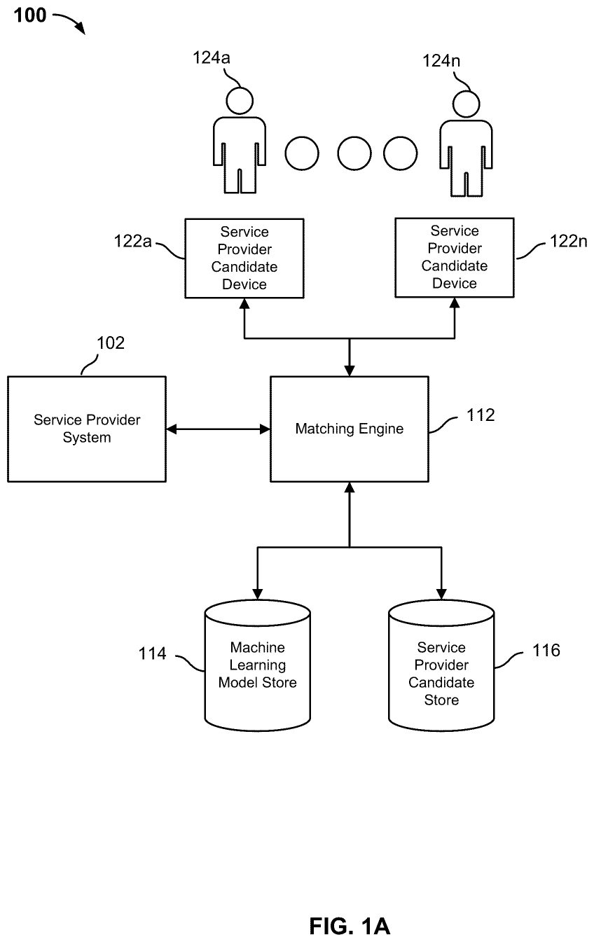

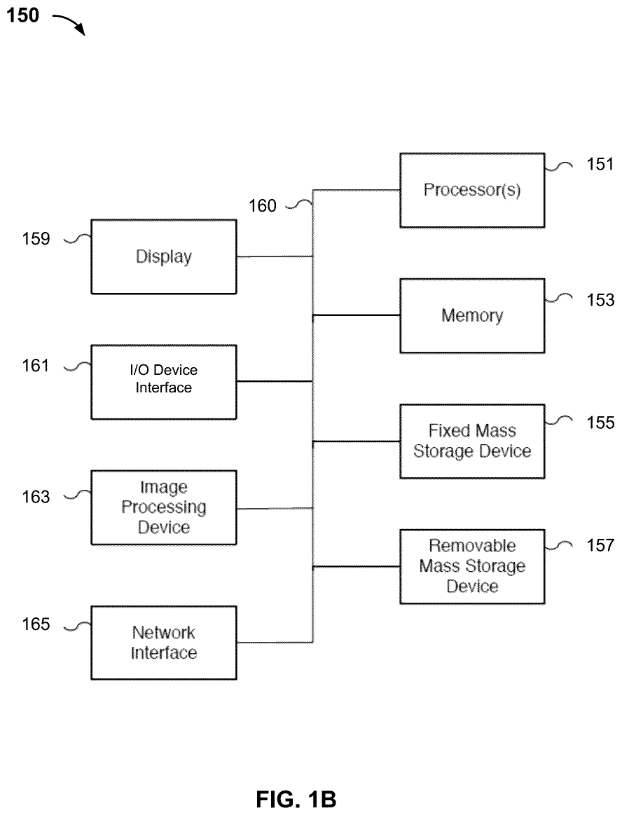

FIG. 1A is a diagram illustrating a system for removing bias when performing a selection operation in accordance with some embodiments. In the example shown, system 100 incudes service provider system 102 coupled to matching engine 112. Matching engine 112 is configured to receive a specification of a desired service in a specific service category from service provider 102. Service provider system 102 may be a server, a laptop, a desktop, a computer, a tablet, a smart device, a smart phone, etc. A service provider may be an individual, a company, an enterprise, a business, an institution, a government, a university, etc. Examples of a service category include, but are not limited to: chief financial officer (CFO), full charge bookkeeping, CPA/accounting advisory, FP&A, tax preparation, etc. The specification of the desired service may include one or more of: a plurality of features, such as a description, a title, a service line, a billing type, a project type, the estimated number of hours for a project, an estimated service provider candidate rate, an estimated start date, an estimated end date, one or more industry tags, one or more software tags, one or more skills tags, call notes, etc.

Matching engine 112 is configured to identify, for the specific service category, a relative component score weighting among the different relative component score weighting options. The plurality of different component scores may include a text match score, a software match score, an industry score, a quality score, a pricing score, and/or a skills score. As discussed above, the relative component score weighting for a particular component score depends on the service category. The matching engine determines, for each component score, the corresponding relative component score weights (e.g., the total number of points allocated to a component score for the service category).

Matching engine 112 is coupled to service provider candidate store 116, which identifies a plurality of service provider candidates for all service categories. Each potential service provider candidate is associated with one or more service categories. The matching engine is configured to filter a set of potential service provider candidates from the plurality of service provider candidates by including in the set of potential service provider candidates one or more service provider candidates having a feature that matches the service category associated with the received specification and excluding from the set of potential service provider candidates one or more service provider candidates not having a feature that matches the service category associated with the received specification.

Matching engine 112 is configured to analyze, for each service provider candidate included in the set of potential service provider candidates, a profile of the service provider candidate by obtaining a machine learning model from machine learning model store 114 and using the obtained machine learning model to determine at least one component score among the plurality of different component scores for the service provider candidate. Machine learning model store 114 stores a plurality of different machine learning models. Each of the machine learning models is associated with a different service category and is configured to compute a total score that indicates a likelihood that the service provider will select a service provider candidate in a particular service category.

The profile of the service provider candidate may include a plurality of features, such as one or more skill tags that indicate skill(s) possessed by the service provider candidate, one or more software tags that indicate software with which the service provider candidate is proficient, one or more industry tags that indicate the industry or industries with which the service provider candidate has experience, a quality tag that indicates an estimated quality of work associated with the service provider candidate, an estimated service provider candidate rate, etc. The profile may include one or more free form text sections, such as an “About Me section” that enables the service provider candidate to describe themselves in words.

Matching engine 112 is configured to determine a first component score for the service provider candidate by determining a similarity between the received specification of the desired service and the profile of the service provider candidate. Matching engine 112 may generate a first embedding for the received specification of the desired service by applying one or more sentence transformers to a description portion of specification of the desired service and a second embedding for one or more free form text sections of the profile of the service provider candidate. The first embedding is a vector representation of the text included in the description portion of the specification of the desired service. The second embedding is a vector representation of the text included in the one or more free form text sections of the profile of the service provider candidate. In some embodiments, matching engine 112 determines the similarity between the first embedding and the second embedding by computing a cosine similarity.

Matching engine 112 is configured to allocate points to a component score based on whether a tag included in the received specification matches a tag included in the profile of the service provider candidate. Matching engine 112 is configured to allocate points to a component score for a service provider candidate based on their quality rating. Matching engine 112 is configured to allocate points to a component score based on whether a cost associated with the service provider candidate (e.g., service provider candidate rate ($/hour)×length of project (# of hours, # of weeks, # of months, etc.)) is within an expected budget for the desired service as specified in the specification of the desired service.

Matching engine 112 is configured to calculate a total score for the plurality of different component scores based on the identified relative component score weighting for the specific service category. In some embodiments, matching engine 112 adds the different component scores to determine the total score. In some embodiments, a weighting value is applied to each of the different component scores.

After determining a corresponding total score for each of the service provider candidates included in the set of potential service provider candidates, matching engine is configured to compare the potential service provider candidate scores to a threshold score and select one or more service provider candidates having a corresponding total score that is above the threshold score. In some embodiments, the total number of service provider candidates provided to the service provider is limited to a particular number of service provider candidates (e.g., 5). In some embodiments, matching engine 112 selects to include in a list of service provider candidates one or more experienced potential service candidates (i.e., assigned to a previous service for a different or the same service provider) and one or more new service candidates (i.e., new to the platform).

Matching engine 112 is configured to receive feedback regarding the list of service provider candidate(s) from the service provider via service provider system 102. Such feedback may be used to re-train the machine learning model associated with the specific service category. Matching engine 112 may receive from the service provider an approval indication. In response to receiving the approval indication, matching engine may provide to the service provider candidate devices 122a . . . 122n associated with service provider candidates 124a . . . 124n included in the list, a proposal to perform the desired service included in the specification. A service provider candidate device may include a laptop, a desktop, a computer, a tablet, a smartphone, a smart device, etc.

A response may be received from one of the service provider candidate devices 122a . . . 122n. The response may include a pitch describing why the service provider candidate is a good fit and should be selected to perform the proposal. Subsequently, the response that includes the pitch is provided to service provider system 102. The service provider may then decide whether to move forward with the service provider candidate for the desired service.

FIG. 1B is a functional diagram illustrating a programmed computer system for matching one or more service provider candidates to a specification of a desired service in a specific service category in accordance with some embodiments. In the example shown, programmed computer system 150 may be implemented as the matching engine 112 of FIG. 1A.

As will be apparent, other computer system architectures and configurations can be used to perform the described product generation technique. Computer system 1500, which includes various subsystems as described below, includes at least one microprocessor subsystem (also referred to as a processor or a central processing unit (CPU) 151). In some embodiments, computer system 150 is a virtualized computer system providing the functionality of a physical computer system. For example, processor 151 can be implemented by a single-chip processor or by multiple processors. In some embodiments, processor 151 is a general purpose digital processor that controls the operation of the computer system 150. In some embodiments, processor 151 also includes one or more coprocessors or special purpose processors (e.g., a graphics processor, a network processor, etc.). Using instructions retrieved from memory 153, processor 151 controls the reception and manipulation of input data received on an input device (e.g., keyboard 161, image processing device 163, etc.), and the output and display of data on output devices (e.g., display 159).

In some embodiments, processor 151 is used to select one or more service provider candidates for a specification of a desired service in a specific service category. optimize product suggestions for a group of customers. The one or more selected service provider candidates is provided to a service provider, which in response, may select one of the one or more selected service provider candidates for the desired service. In some embodiments, processor 151 is used to train a plurality of machine learning models for different service categories. Each of the machine learning models is configured to compute a total score that indicates a likelihood that the service provider will select a service provider candidate. The total score is based on a plurality of different component scores. Processor 151 is used to train a machine learning model to determine the number of points of the total points that is to be allocated to a particular component score. In some embodiments, processor 151 trains a supervised machine learning model to determine the number of points of the total points that is to be allocated to a particular component score. For example, the supervised machine learning model may utilize regression, naïve bayes, classification (e.g., K-nearest neighbor, random forest, support vector machines, decision tree, linear classifiers), neural networks, random forest, etc.

In some embodiments, processor 151 trains an unsupervised machine learning model to determine the number of points of the total points that is to be allocated to a particular component score. For example, the unsupervised machine learning model may utilize K-means clustering, k-nearest neighbors, hierarchical clustering, anomaly detection, neural networks, principle component analysis, independent component analysis, apriori algorithm, etc.

In some embodiments, processor 151 trains a semi-supervised machine learning model to determine the number of points of the total points that is to be allocated to a particular component score. For example, the semi-supervised machine learning model may utilize self-training, co-training, SSL with graph-based label propagation, speech recognition, web content classification, text document classification, etc.

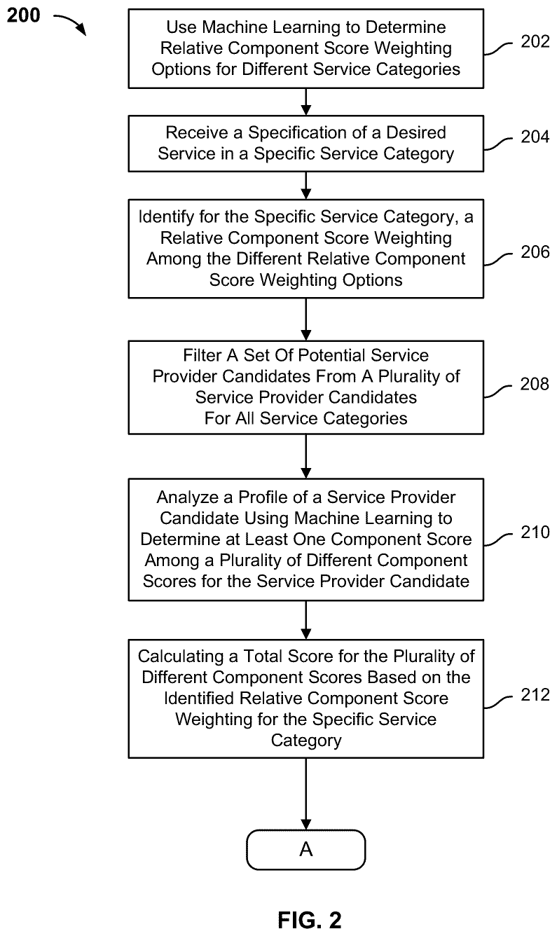

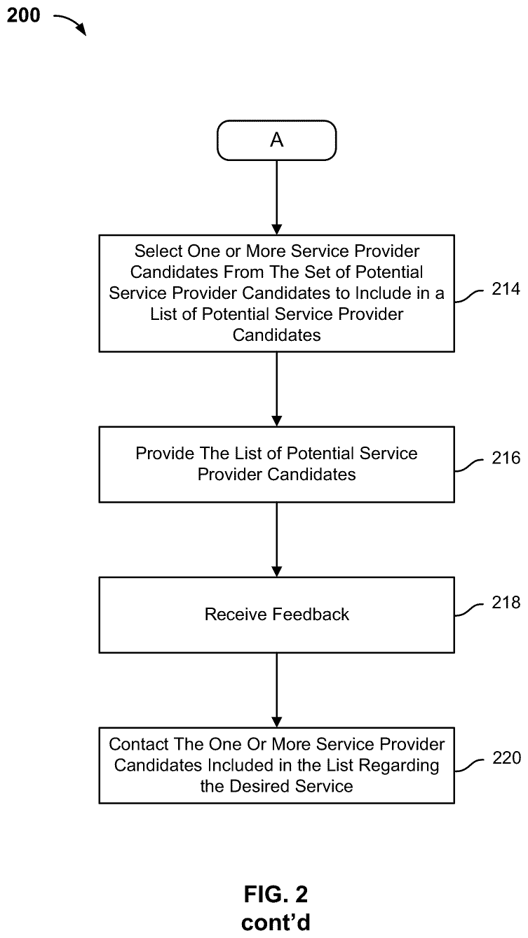

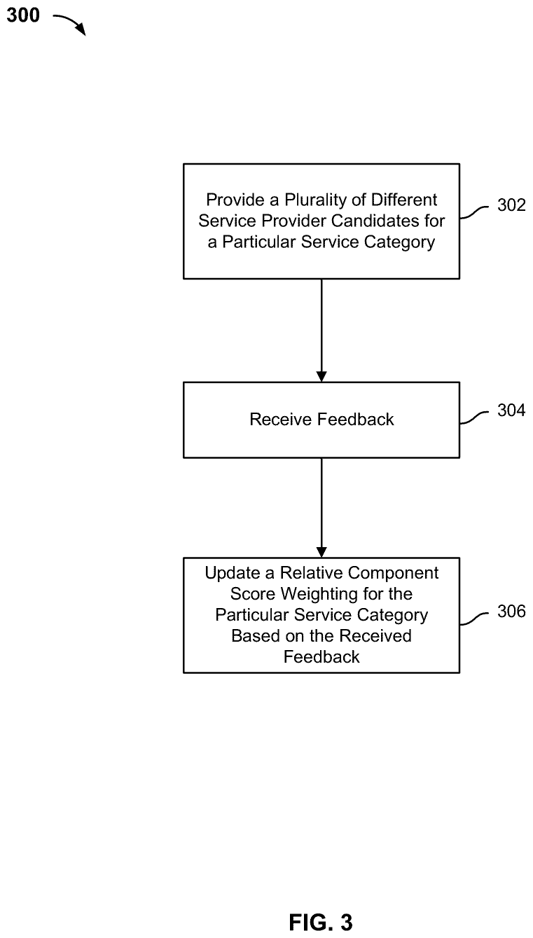

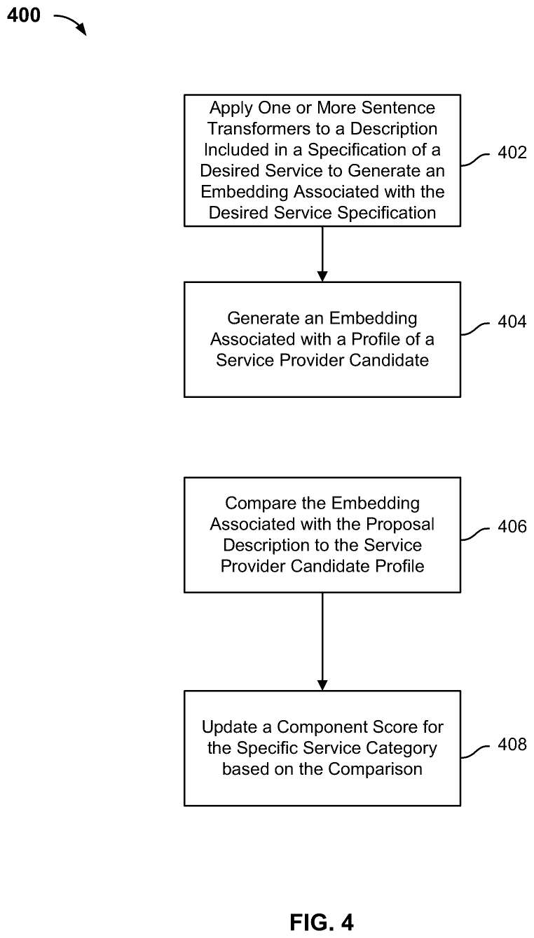

In some embodiments, processor 151 includes and/or is used to provide elements 202, 204, 206, 208, 210, 212, 214, 216, and/or 218 with respect to FIG. 2. In some embodiments, processor 151 is used to communicate with or provide the functionality of machine learning model store 114 and service provider candidate store 116 store of FIG. 1A. In some embodiments, processor 151 performs the processes described below with respect to FIGS. 3 and 4.

Processor 151 is coupled bi-directionally with memory 153, which can include, for example, one or more random access memories (RAM) and/or one or more read-only memories (ROM). As is well known in the art, memory 153 can be used as a general storage area, a temporary (e.g., scratch pad) memory, and/or a cache memory. Memory 153 can also be used to store input data and processed data, as well as to store programming instructions and data, in the form of data objects and text objects, in addition to other data and instructions for processes operating on processor 151. Also as is well known in the art, memory 153 typically includes basic operating instructions, program code, data, and objects used by the processor 151 to perform its functions (e.g., programmed instructions). For example, memory 153 can include any suitable computer readable storage media described below, depending on whether, for example, data access needs to be bi-directional or uni-directional. For example, processor 151 can also directly and very rapidly retrieve and store frequently needed data in a cache memory included in memory 153.

A removable mass storage device 157 provides additional data storage capacity for the computer system 150, and is optionally coupled either bi-directionally (read/write) or uni-directionally (read only) to processor 151. A fixed mass storage 155 can also, for example, provide additional data storage capacity. For example, storage devices 155 and/or 157 can include computer readable media such as magnetic tape, flash memory, PC-CARDS, portable mass storage devices such as hard drives (e.g., magnetic, optical, or solid state drives), holographic storage devices, and other storage devices. Mass storages 155 and/or 157 generally store additional programming instructions, data, and the like that typically are not in active use by the processor 151. It will be appreciated that the information retained within mass storages 155 and 157 can be incorporated, if needed, in standard fashion as part of memory 153 (e.g., RAM) as virtual memory.

In addition to providing processor 151 access to storage subsystems, bus 160 can be used to provide access to other subsystems and devices as well. As shown, these can include a display 159, a network interface 165, an input/output (I/O) device interface 161, an image processing device 163, as well as other subsystems and devices. For example, image processing device 163 can include a camera, a scanner, etc.; I/O device interface 161 can include a device interface for interacting with a touchscreen (e.g., a capacitive touch sensitive screen that supports gesture interpretation), a microphone, a sound card, a speaker, a keyboard, a pointing device (e.g., a mouse, a stylus, a human finger), a Global Positioning System (GPS) receiver, an accelerometer, and/or any other appropriate device interface for interacting with system 150. Multiple I/O device interfaces can be used in conjunction with computer system 150. The I/O device interface can include general and customized interfaces that allow the processor 151 to send and, more typically, receive data from other devices such as keyboards, pointing devices, microphones, touchscreens, transducer card readers, tape readers, voice or handwriting recognizers, biometrics readers, cameras, portable mass storage devices, and other computers.

The network interface 165 allows processor 151 to be coupled to another computer, computer network, or telecommunications network using a network connection as shown. For example, through the network interface 165, the processor 151 can receive information (e.g., data objects or program instructions) from another network, or output information to another network in the course of performing method/process steps. Information, often represented as a sequence of instructions to be executed on a processor, can be received from and outputted to another network. An interface card or similar device and appropriate software implemented by (e.g., executed/performed on) processor 151 can be used to connect the computer system 150 to an external network and transfer data according to standard protocols. For example, various process embodiments disclosed herein can be executed on processor 151, or can be performed across a network such as the Internet, intranet networks, or local area networks, in conjunction with a remote processor that shares a portion of the processing. Additional mass storage devices (not shown) can also be connected to processor 151 through network interface 165.

In addition, various embodiments disclosed herein further relate to computer storage products with a computer readable medium that includes program code for performing various computer-implemented operations. The computer readable medium includes any data storage device that can store data which can thereafter be read by a computer system. Examples of computer readable media include, but are not limited to: magnetic media such as disks and magnetic tape; optical media such as CD-ROM disks; magneto-optical media such as optical disks; and specially configured hardware devices such as application-specific integrated circuits (ASICs), programmable logic devices (PLDs), and ROM and RAM devices. Examples of program code include both machine code as produced, for example, by a compiler, or files containing higher level code (e.g., script) that can be executed using an interpreter.

The computer system shown in FIG. 1B is but an example of a computer system suitable for use with the various embodiments disclosed herein. Other computer systems suitable for such use can include additional or fewer subsystems. In some computer systems, subsystems can share components (e.g., for touchscreen-based devices such as smart phones, tablets, etc., I/O device interface 161 and display 159 share the touch sensitive screen component, which both detects user inputs and displays outputs to the user). In addition, bus 160 is illustrative of any interconnection scheme serving to link the subsystems. Other computer architectures having different configurations of subsystems can also be utilized.

FIG. 2 is a flow diagram illustrating a process for removing bias when performing a selection operation in accordance with some embodiments. In the example shown, process 200 may be implemented by a matching engine, such as matching engine 112.

At 202, machine learning is used to determine relative component score weighting options for different service categories. A plurality of machine learning models may be generated for the different service categories (e.g., chief financial officer (CFO), full charge bookkeeping, CPA/accounting advisory, FP&A, tax preparation, etc.). A machine learning model is configured to compute a total score that indicates a likelihood that the service provider will select a service provider candidate in the service category for which the machine learning model is trained.

The total score is based on a plurality of different component scores. For example, the plurality of different component scores may include a text match score, a software match score, an industry score, a quality score, a pricing score, and/or a skills score. Each of the different component scores is associated with a relative component score weighting. The relative component score weighting associated with a component score may be based on service category. For example, the skills score may have a first relative component score weighting for a first service category and a second relative component score weighting for a second service category. A total score associated with a service provider candidate may be a score that is greater than and equal to 0 points and less than and equal to 100 points. Each of the different component scores may be allotted a particular number of points (e.g., 10 points). The different component scores may initially have an equal weight, that is, each of the different component scores are allocated an equal number of points. For example, the text match score, the software match score, the industry score, the quality score, the pricing score, and the skills score may be initially allocated 12.5 points.

The plurality of machine learning models may be trained in a manner that adjusts the relative weight given to a component score based on the service category. The number of points allocated to a particular score may be different. For example, the software match score may be allocated 20 points for a first service category and 15 points for a second service category. In some embodiments, a relative component score weighting for a component score is a multiplier value between 0 and 1. In some embodiments, the matching engine implements a supervised machine learning model (e.g., linear regression) to determine the different relative component weighting options for different service categories. For example, the machine learning model may determine, for a first service category, to allocate 25 points to a text match score, 15 points to a software match score, 20 points to an industry match score, 15 points to a quality score, 10 points to a pricing score, and 15 points to a skills score. The machine learning model may determine, for a second service category, to allocate 30 points to a text match score, 15 points to a software match score, 15 points to an industry match score, 10 points to a quality score, 10 points to a pricing score, and 20 points to a skills score.

At 204, a specification of a desired service in a specific service category is received. The specification of the desired service may include one or more of: a plurality of features, such as a description, a title, a service line, a billing type, a project type, the estimated number of hours for a project, an estimated service provider candidate rate, an estimated start date, an estimated end date, one or more industry tags, one or more software tags, one or more skills tags, call notes, etc.

At 206, a relative component score weighting among the different relative component score weighting options is identified for the specific service category. The relative component score weighting for a particular component score depends on the service category. The matching engine determines, for each component score, the corresponding relative component score weights (e.g., the total number of points allocated to a component score for the specific service category).

At 208, a set of potential service provider candidates is filtered from a plurality of service provider candidates for all service categories. The matching engine is coupled to a database that identifies a plurality of service provider candidates for all service categories. Each potential service provider candidate is associated with one or more service categories. The matching engine filters a set of potential service provider candidates from the plurality of service provider candidates by including in the set of potential service provider candidates one or more service provider candidates having a feature that matches the service category associated with the received specification and excluding from the set of potential service provider candidates one or more service provider candidates not having a feature that matches the service category associated with the received specification. For example, the feature may be an industry tag.

At 210, a profile of a service provider candidate is analyzed using machine learning to determine at least one component score among a plurality of different component scores for the service provider candidate. The matching engine is coupled to a database that stores profiles associated with the plurality of service provider candidates. Step 210 may be performed for each service provider candidate included in the set of potential service provider candidates.

The profile of the service provider candidate may include a plurality of features, such as one or more skill tags that indicate skill(s) possessed by the service provider candidate, one or more software tags that indicate software with which the service provider candidate is proficient, one or more industry tags that indicate the industry or industries with which the service provider candidate has experience, a quality tag that indicates an estimated quality of work associated with the service provider candidate, an estimated service provider candidate rate, etc. The profile may include one or more free form text sections, such as an “About Me section” that enables the service provider candidate to describe themselves in words.

In some embodiments, the matching engine determines a first component score for the service provider candidate by determining a similarity between the received specification of the desired service and the profile of the service provider candidate. The matching engine may generate a first embedding for the received specification of the desired service by applying one or more sentence transformers to a description portion of specification of the desired service and a second embedding for one or more free form text sections of the profile of the service provider candidate. The first embedding is a vector representation of the text included in the description portion of the specification of the desired service. The second embedding is a vector representation of the text included in the one or more free form text sections of the profile of the service provider candidate.

In some embodiments, the matching engine determines the similarity between the first embedding and the second embedding by computing a cosine similarity. The first component score may be allocated a certain number of points (e.g., 30 points). In some embodiments, the matching engine allocates all of the points allocated to the first component score for a cosine similarity value of 1. In some embodiments, the matching engine does not allocate any of the points allocated to the first component score for a cosine similarity value of 0. In some embodiments, the matching engine allocates some of the points allocated to the first component score for a cosine similarity value that is between 0 and 1. The number of points allocated may be scaled based on the cosine similarity value. For example, the number of points allocated to the first component score may be 30 and the cosine similarity value may be 0.5. The matching engine may allocate 15 points to the first component score for the service provider candidate.

At 212, a total score for the plurality of different component scores is calculated based on the identified relative component score weighting for the specific service category. Step 212 may be performed for each service provider candidate included in the set of potential service provider candidates.

The total score may be based on a text match score, a software match score, an industry score, a quality score, a pricing score, and/or a skills score. The number of points allocated to each score depends on the specific service category.

The text match score may be equal to the first component score described above.

The software match score may be based on whether the profile of the service provider candidate includes one or more tags included in the specification of the desired service. For example, the desired service specification may include a first tag for a first software application and a second tag for a second software application. The software match score may be allocated 10 points for the specific service category. The service provider candidate may be allocated 5 points if the service provider candidate profile includes the first tag for the first software application and 5 points if the service provider candidate profile includes the second tag for the second software application. In a second example, the software match score may be allocated 20 points for a different service category. The service provider candidate may be allocated 10 points if the service provider candidate profile includes the first tag for the first software application and 10 points if the service provider candidate profile includes the second tag for the second software application. The number of points allocated to a tag depends on the number of software tags. The number of points allocated to a tag is equal to the total number of points allocated to the software match score divided by the number of software tags included in the desired service specification.

The industry score may be based on whether the service provider candidate profile includes an industry tag that is included in the desired service specification.

The quality score may be based on a quality rating associated with the service provider candidate. For example, the total number of points allocated to a quality score may be 15 points. In some embodiments, the matching engine allocates 15 points to the service provider candidate for having a platinum rating, 12 points for having a gold rating, 9 points for having a silver rating, and 6 points for having a bronze rating. A service provider candidate's quality score is based on feedback provided by one or more previous services performed by the service provider candidate for one or more other service providers. The quality score may based on a number of services that the service provider candidate is able to perform per month or other time period. The quality score may be based on how often the service provider candidate is selected by a service provider to perform the desired service.

In some embodiments, a service provider candidate is a new service provider candidate. In such embodiments, the service provider candidate may be allocated a default number of points (e.g., 10 points).

The pricing score may be based on whether a cost associated with the service provider candidate (e.g., service provider candidate rate ($/hour)×length of project (# of hours, # of weeks, # of months, etc.)) is within an expected budget for the desired service as specified in the desired service specification. In some embodiments, a service provider candidate is allocated the full number of points if the cost associated with the service provider candidate is within the expected budget for the desired service. In some embodiments, a service provider candidate is allocated some of the points if the cost associated with the service provider candidate exceeds the expected budget, but less than a first threshold (e.g., a percentage over the expected budget, an amount over the expected budget). In some embodiments, a service provider candidate is allocated none of the points if the cost associated with the service provider candidate exceeds the expected budget and is greater than the first threshold.

The skills score may be based on whether the service provider candidate profile includes one or more skills tag that are included in the desired service specification.

The matching engine may calculate a total score for the plurality of different component scores based on the identified relative component score weighting for the specific service category. In some embodiments, the matching engine adds the different component scores to determine the total score. In some embodiments, a weighting value is applied to each of the different component scores.

At 214, one or more service provider candidates are selected from the set of potential service provider candidates to include in a list of potential service provider candidates. After determining a corresponding total score for each of the service provider candidates included in the set of potential service provider candidates, the matching engine may compare the potential service provider candidate scores to a threshold score and select one or more service provider candidates having a corresponding total score that is above the threshold score. In some embodiments, the total number of service provider candidates provided to the service provider is limited to a particular number of service provider candidates (e.g., 5). In some embodiments, the matching engine selects to include in the list of potential service provider candidates one or more experienced potential service candidates (i.e., assigned to a previous service for a different or the same service provider) and one or more new service candidates (i.e., new to the platform). This removes the subjective bias that an individual may introduce when selecting service provider candidates for the desired service because new and experienced potential service candidates are included in the list. The individual using their subject bias may only select experienced potential candidates service candidates with which they previously worked.

At 216, a list of potential service provider candidate(s) is provided to the service provider.

At 218, feedback is received from the service provider. In some embodiments, the received feedback removes one or more service provider candidates from the list. In some embodiments, the received feedback provides explicit recommendation feedback (e.g., thumbs up or thumbs down). The feedback may include a request to contact the one or more service provider candidates included in the list regarding the desired service. In some embodiments, step 218 is optional (e.g., the service provider does not provide any feedback).

At 220, the matching engine contacts (e.g., sends out an email) the one or more service provider candidates included in the list regarding the desired service.

FIG. 3 is a flow diagram illustrating a process for retraining a machine learning model in accordance with some embodiments. In the example shown, process 300 may be implemented by a matching engine, such as matching engine 112. In some embodiments, process 300 is implemented to perform some of step 202 of process 200.

At 302, a plurality of different service provider candidates for a particular service category is provided.

At 304, feedback is received. In some embodiments, feedback is received from the service provider after a set of one or more service provider candidates is presented to the service provider. For example, the matching engine may recommend five different service provider candidates and the service provider may select four of the five different service provider candidates. In some embodiments, feedback is received from the service provider after a selected service provider candidate has completed the desired service. For example, the service provider may provide feedback that indicates a quality of work performed by a selected service provider candidate did not meet expectations. In response to such feedback, the points allocated to the quality score may be increased.

At 306, a relative component score weighting for the particular service category is updated based on the received feedback. The relative component score weight for a particular component score may increase or decrease from the initial weight based on feedback received from a service provider. The relative component score weights of the component scores for a service category may be updated each time feedback is received from the service provider.

For example, the machine learning model for the particular service category may utilize, at step 302, relative component score weightings of 25 points for a text match score, 15 points for a software match score, 20 points for an industry match score, 15 points for a quality score, 10 points for a pricing score, and 15 points for a skills score.

After the feedback at step 306 is received, the machine learning model for the particular service category may update the relative component score weightings for the particular service category such that 30 points are allocated to a text match score, 15 points are allocated to a software match score, 15 are allocated points to an industry match score, 10 points are allocated to a quality score, 10 points are allocated to a pricing score, and 20 points are allocated to a skills score.

FIG. 4 is a flow diagram illustrating a process for determining a component score for a service provider candidate in accordance with some embodiments. In the example shown, process 400 may be implemented by a matching engine, such as matching engine 112. In some embodiments, process 400 is implemented to perform some of step 210 of process 200.

At 402, one or more sentence transformers are applied to a description included in a specification of a desired service to generate an embedding associated with the desired service specification. The one or more sentence transformers may remove time related information from the description when generating the embedding. In some embodiments, one or more sentence transformers specific to the service category associated with the desired service are applied to the description included in the specification of the desired service.

The one or more sentence transformers are configured to remove extraneous information from the description portion of the specification. The one or more sentence transformers are configured to transform the text included in the description portion of the specification into a better input form for the similarity comparison. The first embedding for the received specification of the desired service may be a different vector representation of the text if the one or more sentence transformers are not applied to the description portion of the desired service specification. As a result, the determined similarity between the first embedding and the second embedding may return a different set of potential service provider candidates than if the one or more sentence transformers are applied to the description portion of the desired service specification. Not applying the one or more sentence transformers to the description portion of the desired service specification may reduce the accuracy of the total score calculated for the service provider candidate by the matching engine (i.e., the likelihood that the service provider will select the service provider candidate) because the first component score for the service provider candidate does not accurate reflect the similarity between the profile of a service provider candidate and the description portion of the desired service specification.

At 404, an embedding associated with a profile of a service provider candidate is generated. The service provider candidate profile may include one or more text sections. An embedding of the service provider candidate profile is generated based on the text included in the one or more text sections.

At 406, the embedding associated with the desired service specification is compared to the embedding associated with the service provider candidate profile. The embedding associated with the desired service specification is a vector that represents the text of the desired specification. The embedding associated with the service provider candidate profile is a vector that represents the text of the service provider candidate profile. The embeddings may be compared by computing a cosine similarity. A cosine similarity value equal to 1 may indicate that the service provider candidate may be a good candidate for the desired service. A cosine similarity value equal to 0 may indicate that the service provider candidate is not a good candidate for the desired service.

At 408, a component score for the specific service category is updated based on the comparison. In some embodiments, the matching engine allocates all of the points allocated to the component score for a cosine similarity value of 1. In some embodiments, the matching engine does not allocate any of the points allocated to the component score for a cosine similarity value of 0. In some embodiments, the matching engine allocates some of the points allocated to the component score for a cosine similarity value that is between 0 and 1. The number of points allocated may be scaled based on the cosine similarity value. For example, the number of points allocated to the component score may be 30 and the cosine similarity value may be 0.5. The matching engine may allocate 15 points to the component score for the service provider candidate.

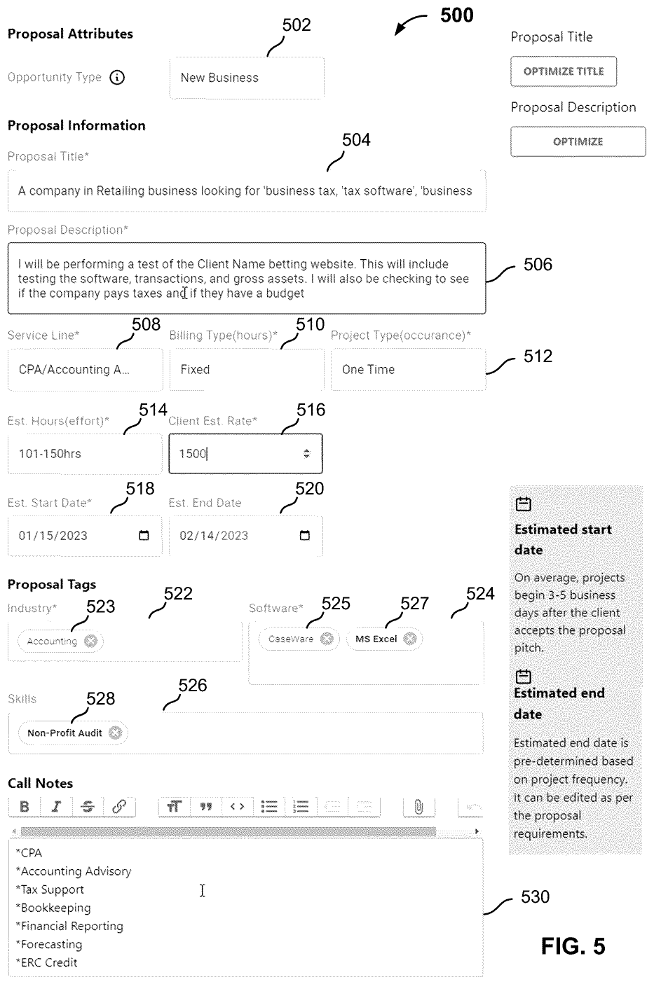

FIG. 5 is an example of a specification of a desired service in a specific service category in accordance with some embodiments. In the example shown, the desired service specification 500 includes a plurality of features, such as opportunity type 502, proposal title 504, proposal description 506, service line 508, billing type 510, project type 512, estimated number of hours 514, estimated client rate 516 (estimated service provider candidate rate), estimated start date 518, estimated end date 520, proposal tags 522, software tags 524, skill tags 526, and call notes 530. The industry tags 522 may include one or more tags. In the example shown, the industry tags include tag 523. The software tags 524 may include one or more tags. In the example shown, the software tags include tags 525, 527. The skills tags 526 may include one or more tags. In the example shown, the skills tags 526 include tag 528.

A tag may be a required tag or an optional tag. A required tag may be bolded in the user interface, for example tags 527, 528. A required tags may be allocated a higher point value than an optional tag.

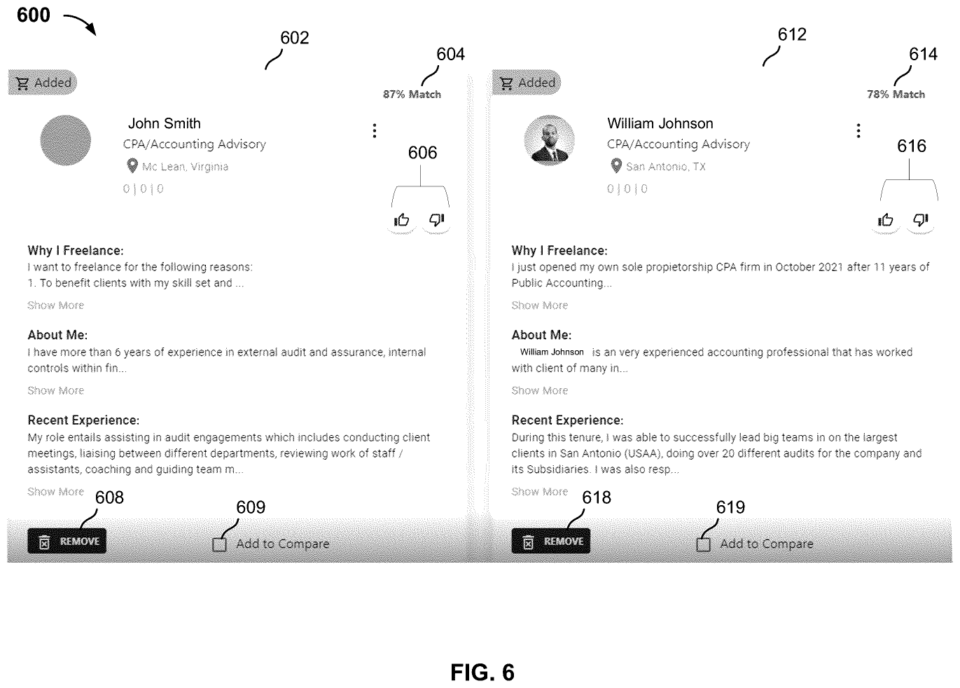

FIG. 6 is an example of a list of service provider candidate profiles in accordance with some embodiments. A preview profile of a first service provider candidate 602 and preview profile of a second service provider candidate profile are shown in list 600. Although list 600 depicts two different service provider candidate profiles, list 600 may include n additional service provider candidate profiles.

The preview profiles include the corresponding total scores 604, 614 for the respective service provide candidates. Feedback associated with a service provider candidate may be received via feedback buttons 606, 606. The preview profiles may include buttons 609, 619 that enable a service provider candidate to which the preview profile is associated to be added to a comparison view that compares a plurality of service provider candidates.

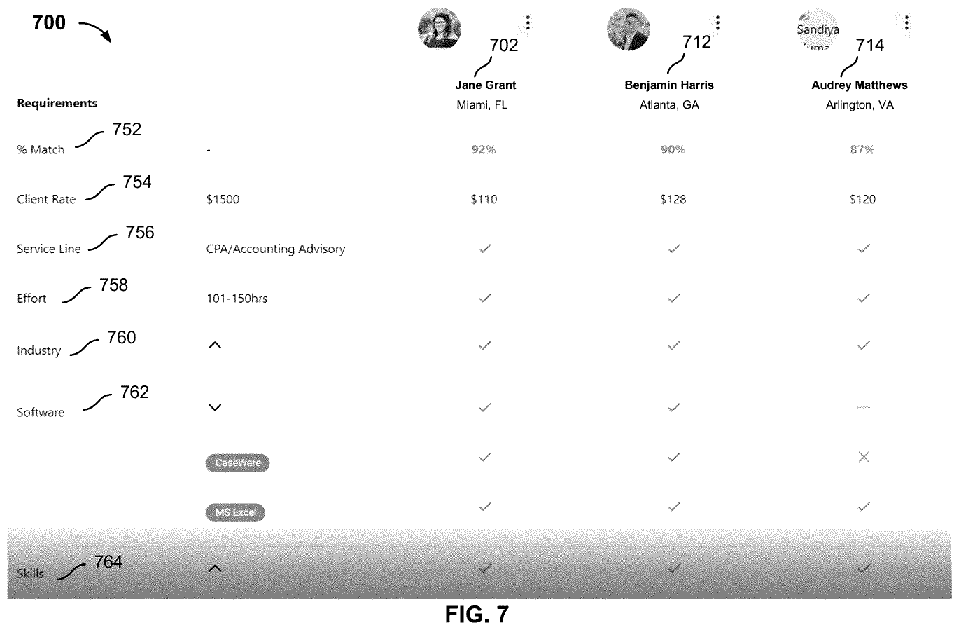

FIG. 7 is an example of a comparison view of service provider candidates in accordance with some embodiments. In the example shown, comparison view 700 compares service provider candidates 702, 712, 722. The comparison view includes the requirements 754, 756, 758, 760, 762 included in a specification of a desired service and indicates whether a service provider candidate meets the requirement. The comparison view also includes a total score 752 (% match) for the service provider candidates 702, 712, 722.

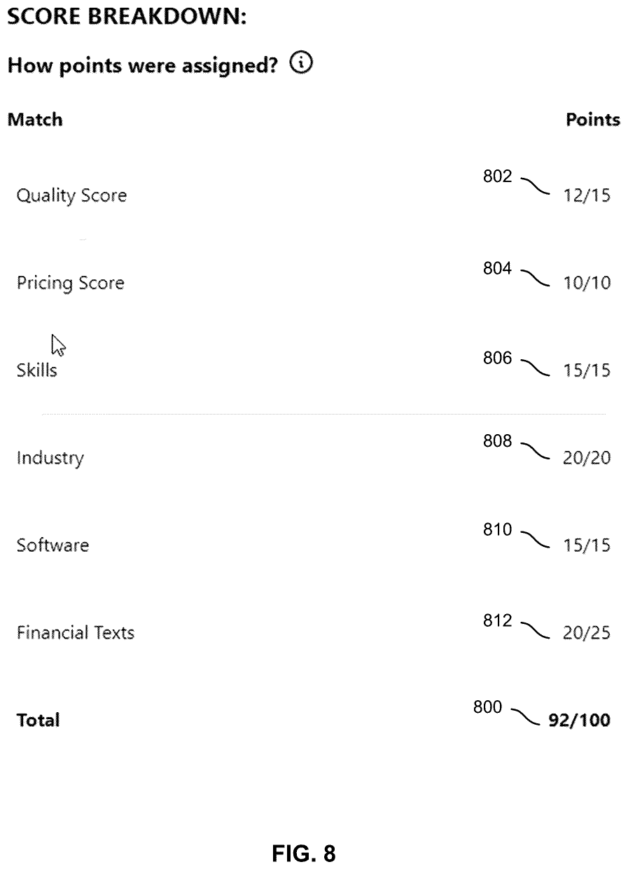

FIG. 8 is an example of a total score associated with a service provider candidate in accordance with some embodiments. In the example shown, a total score 800 is based on a quality score 802, a pricing score 804, skills score 806, an industry score 808, a software score 810, and a text score 812. Each score is allocated a particular number of points. The particular number of points allocated to a score is based on a service category and determined using machine learning. In this example, the quality score 802 is allocated 15 points, the pricing score 804 is allocated 10 points, the skills score 806 is allocated 15 points, the industry score 808 is allocated 20 points, the software score 810 is allocated 15 points, and the texts score 812 is allocated 25 points.

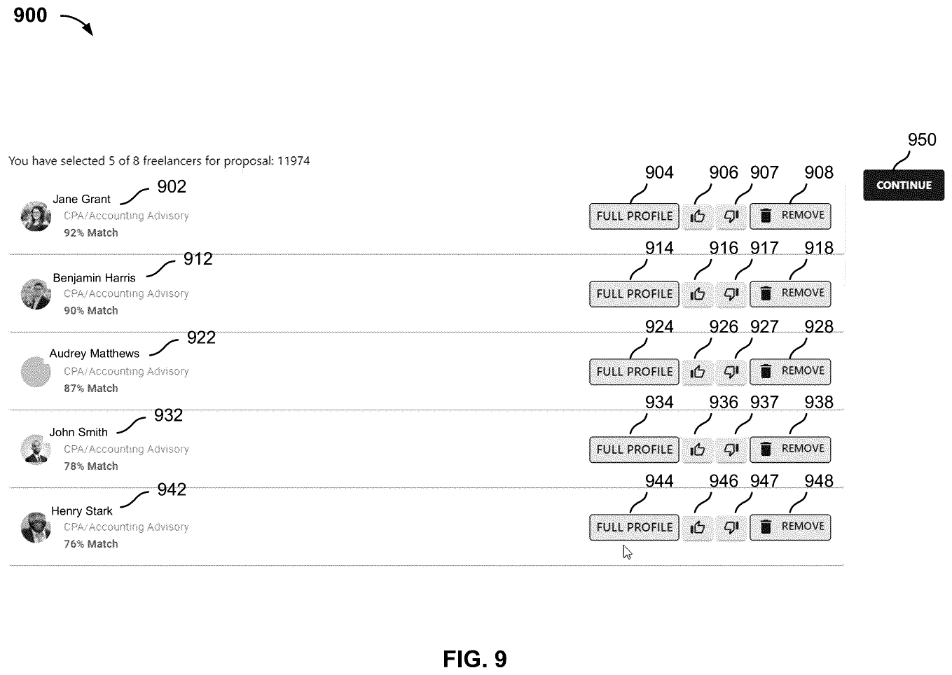

FIG. 9 is a diagram illustrating a list of service provider candidates in accordance with some embodiments. In the example shown, the list 900 includes service provider candidates 902, 912, 922, 932, 942. List 900 provides a service provider with the ability to review a full profile associated with a service provider candidate. The full profile associated with service provider candidate 902 may be provided in response to a selection of full profile button 904, the full profile associated with service provider candidate 912 may be provided in response to a selection of full profile button 914, the full profile associated with service provider candidate 922 may be provided in response to a selection of full profile button 924, the full profile associated with service provider candidate 932 may be provided in response to a selection of full profile button 934, and the full profile associated with service provider candidate 942 may be provided in response to a selection of full profile button 944.

List 900 provides a service with the ability to provide feedback associated with a service provider candidate. Positive feedback may be provided for service provider candidates 902, 912, 922, 932, 942 via thumbs up buttons 906, 916, 926, 936, 946, respectively. Negative feedback may be provided for service provider candidates 902, 912, 922, 932, 942 via thumbs down buttons 907, 917, 927, 937, 947, respectively. Service provider candidates 902, 912, 922, 932, 942 may be removed from list 900 via remove buttons 908, 918, 928, 938, 948, respectively. Such feedback may be used to retrain a machine learning model used to generate list 900 by updating the corresponding weights for each of the plurality of scoring components for the particular service category associated with the machine learning model.

List 900 includes a continue button 950. In response to a selection of continue button 950, a communication (e.g., email, text, voicemail, etc.) may be provided to service candidates 902, 912, 922, 932, 942.

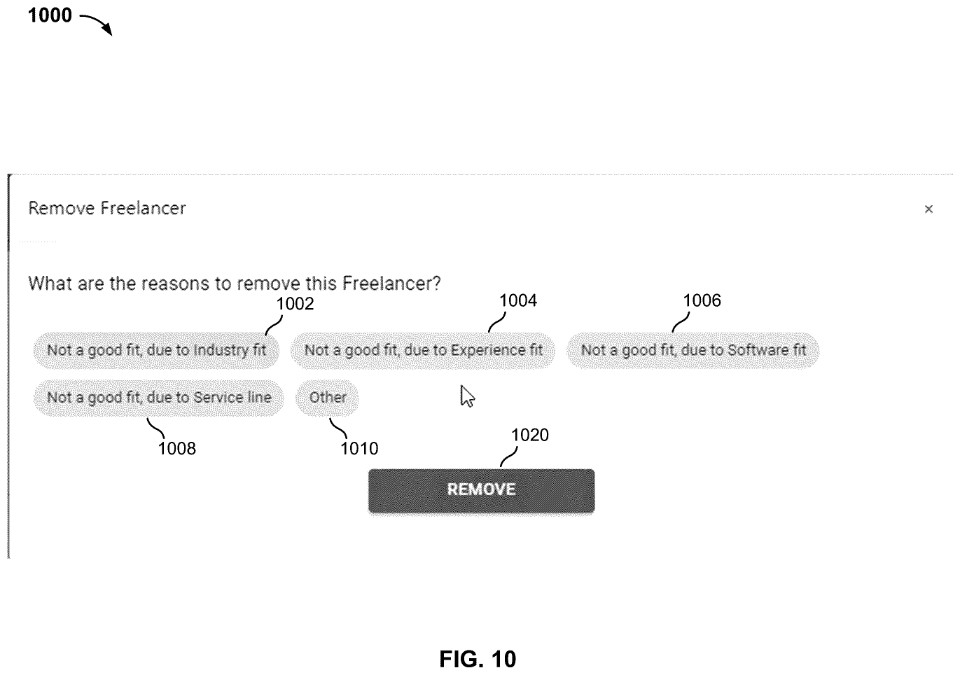

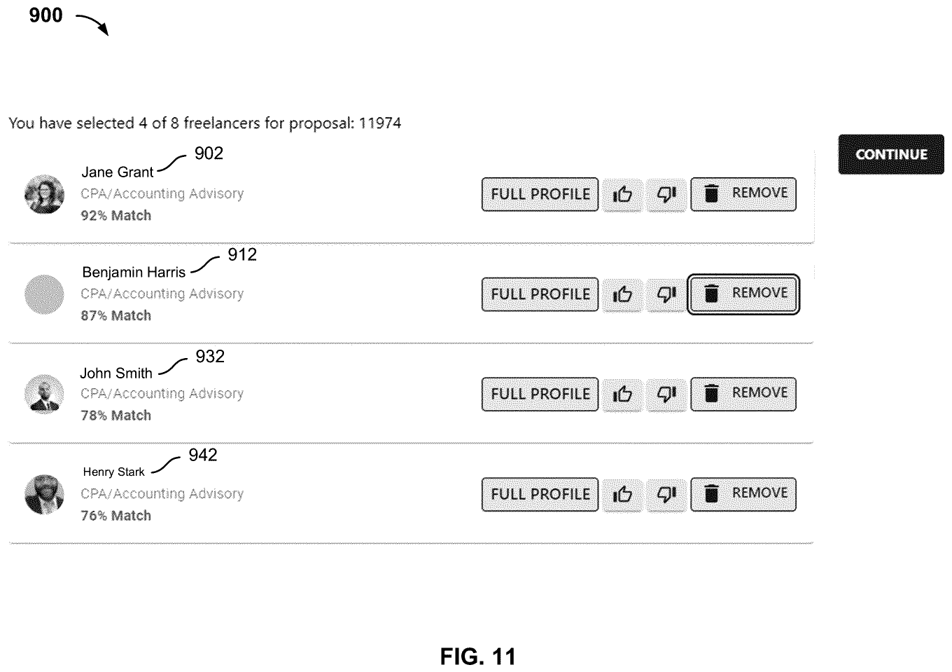

FIG. 10 is an example of feedback screen that is provided in accordance with some embodiments. In the example shown, remove button 928 associated with service provider candidate 922 was selected. In response to the selection, feedback screen 1000 is provided. Feedback screen 1000 includes remove reason buttons 1002, 1004, 1006, 1008, 1010. Each remove reason button indicates a reason why the service provider candidate 922 may be removed from list 900. Feedback screen 1000 provides a service provider with the ability to select one or more of remove reason buttons 1002, 1004, 1006, 1008, 1010. In some embodiments, a service provider selects none of the remove reason buttons 1002, 1004, 1006, 1008, 1010. Feedback screen 1000 includes remove button 1020. In response to a selection of remove button 1020, a service provider candidate is removed from list 900. As seen in FIG. 11, service provider candidate was removed from list 900.

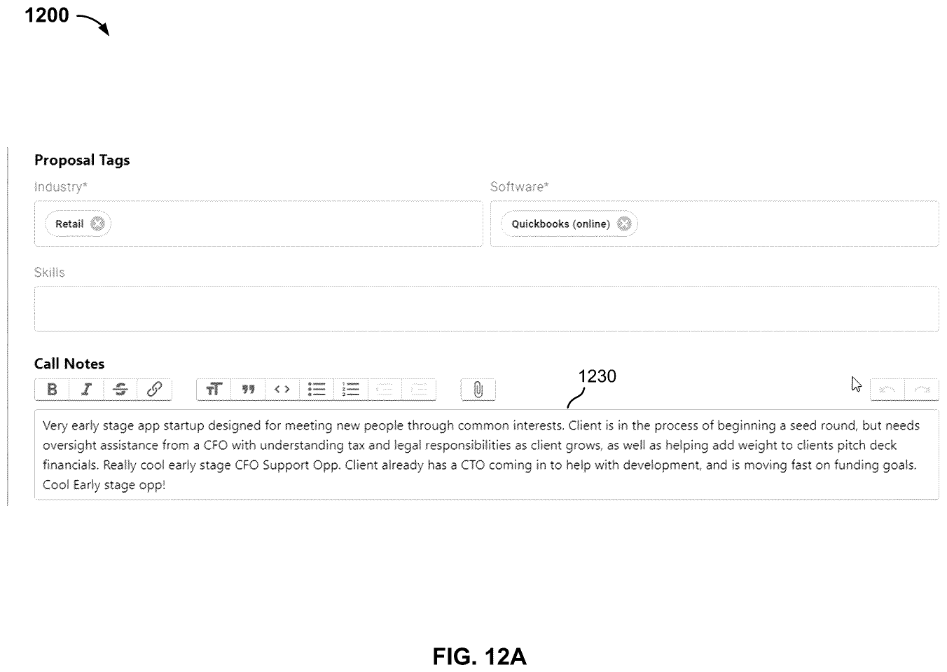

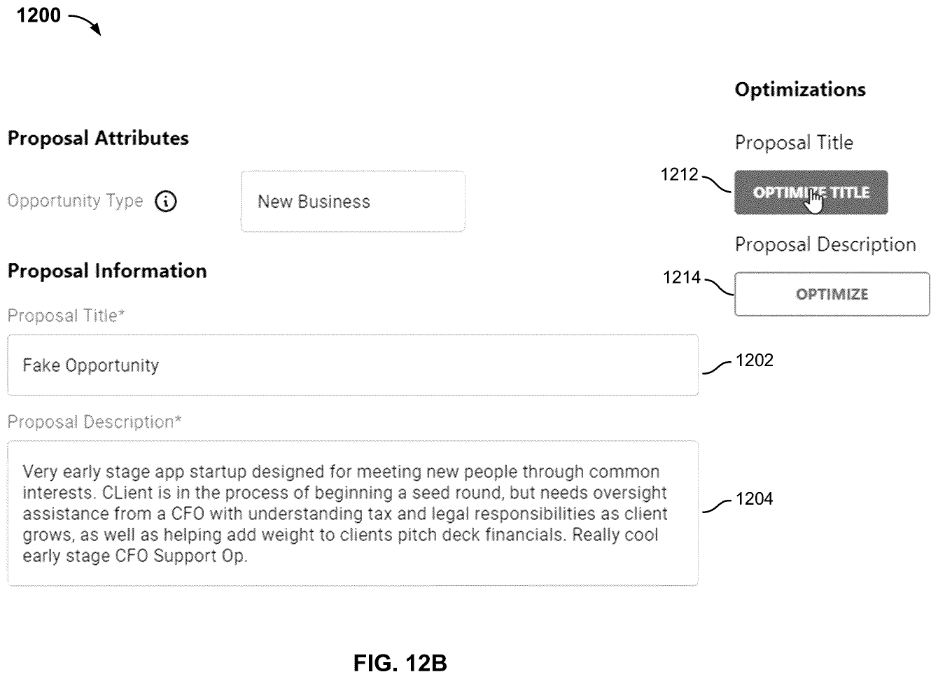

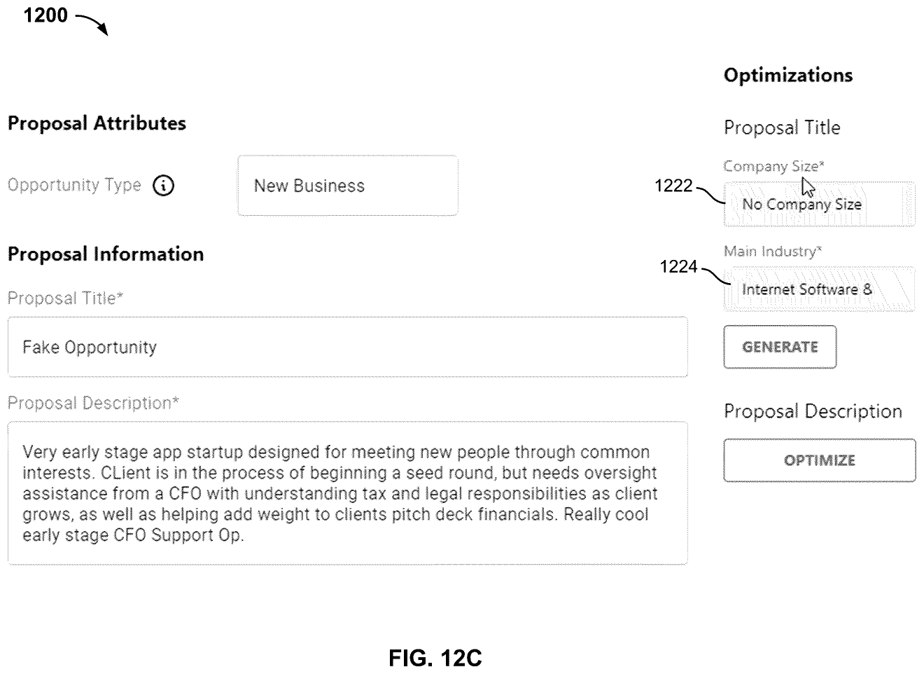

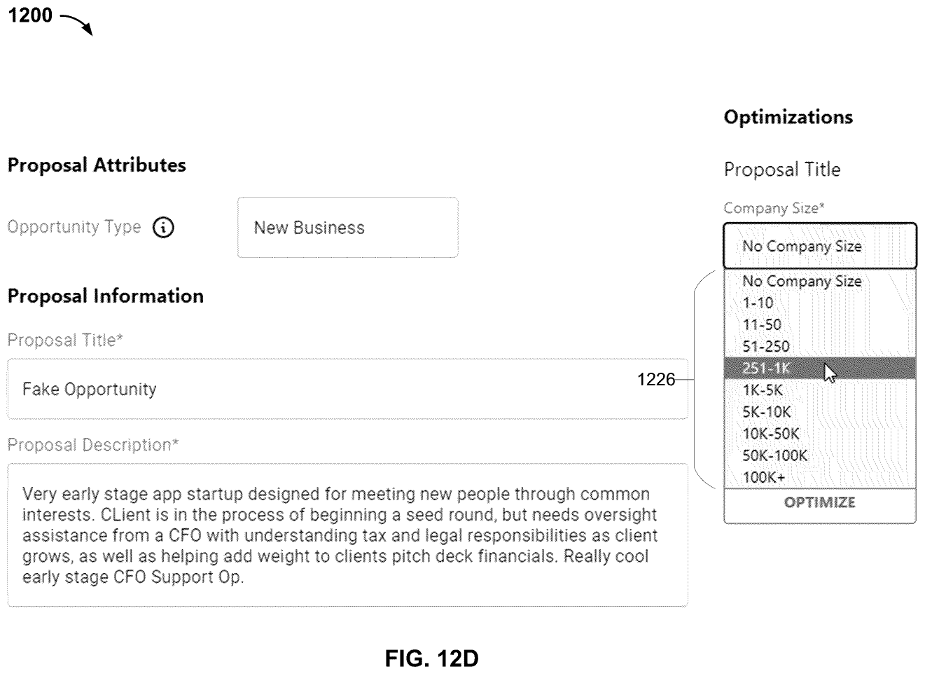

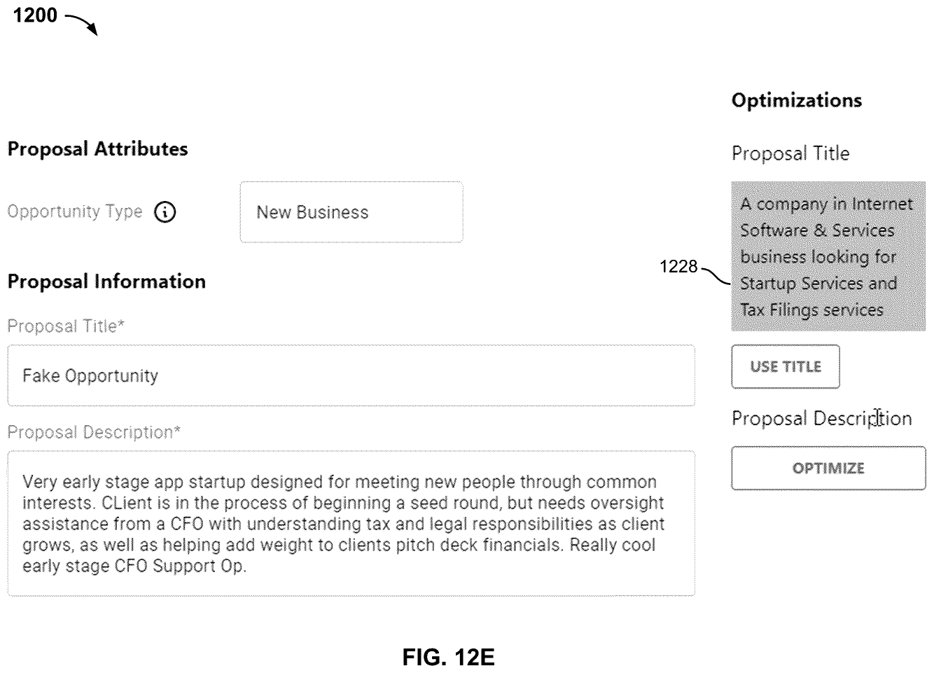

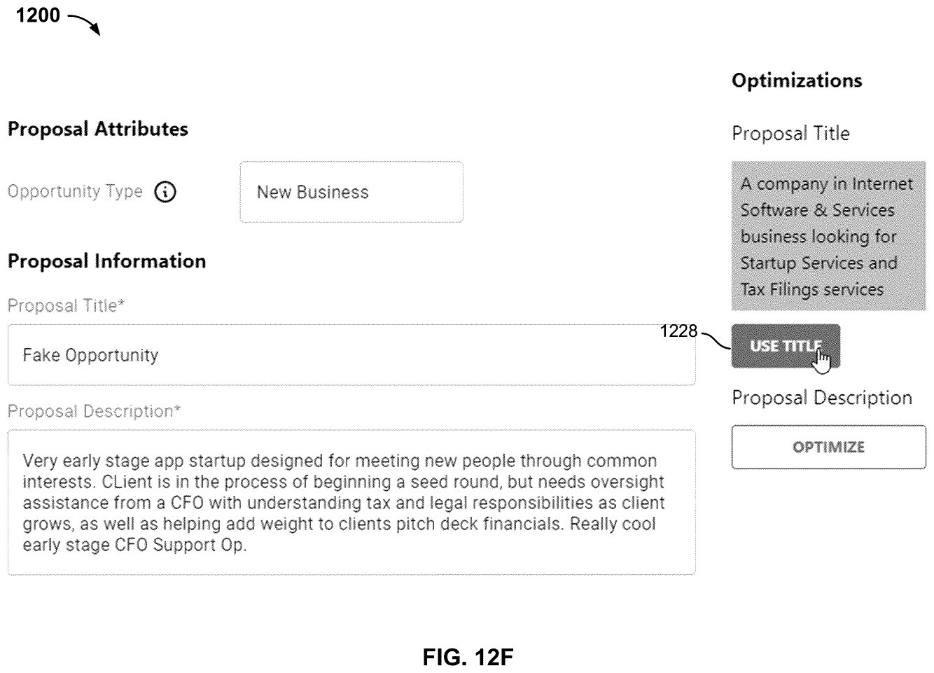

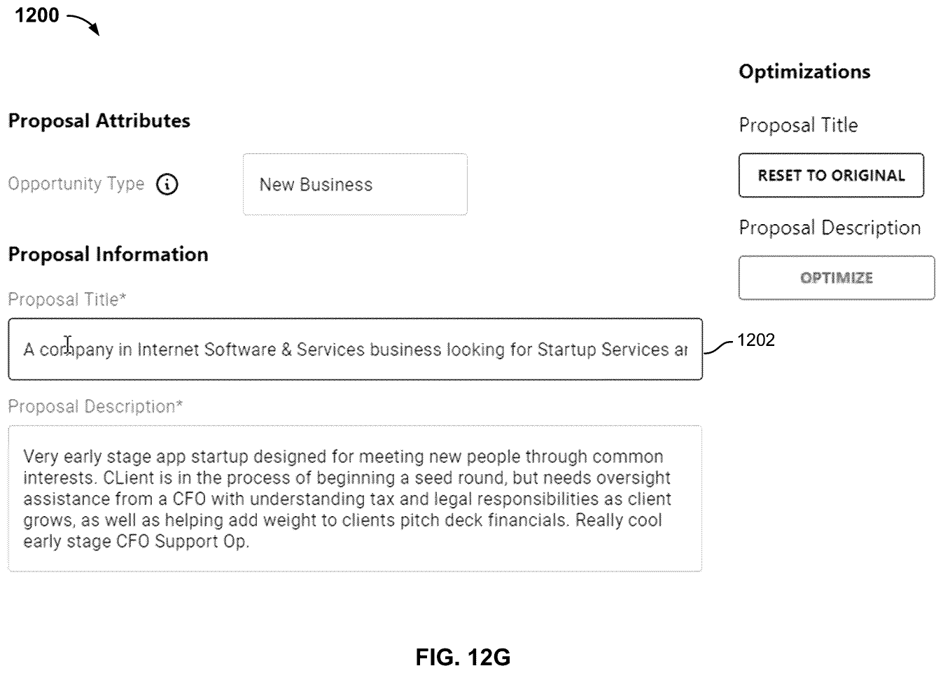

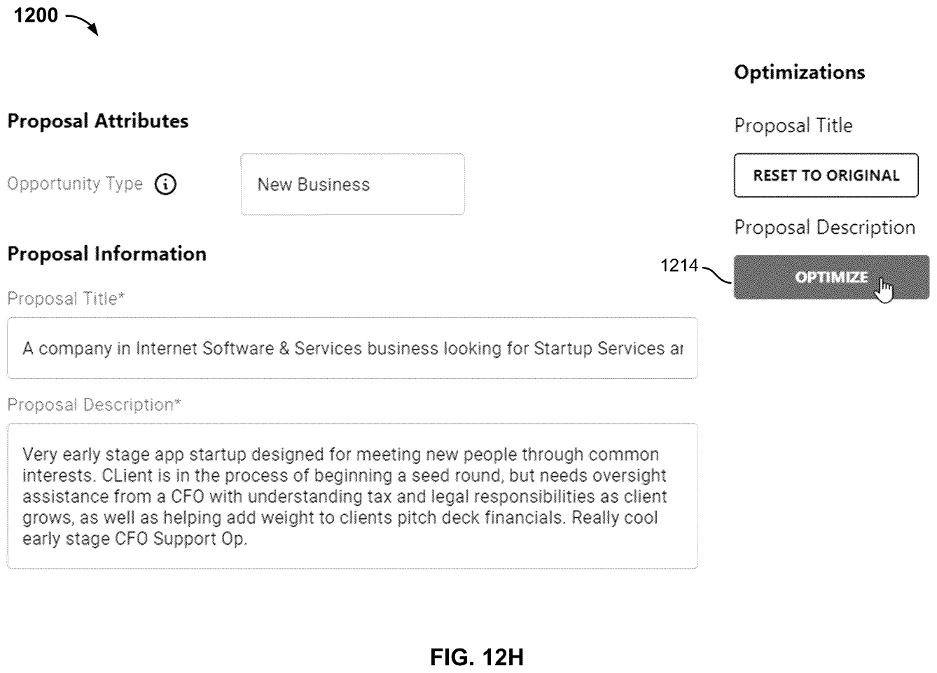

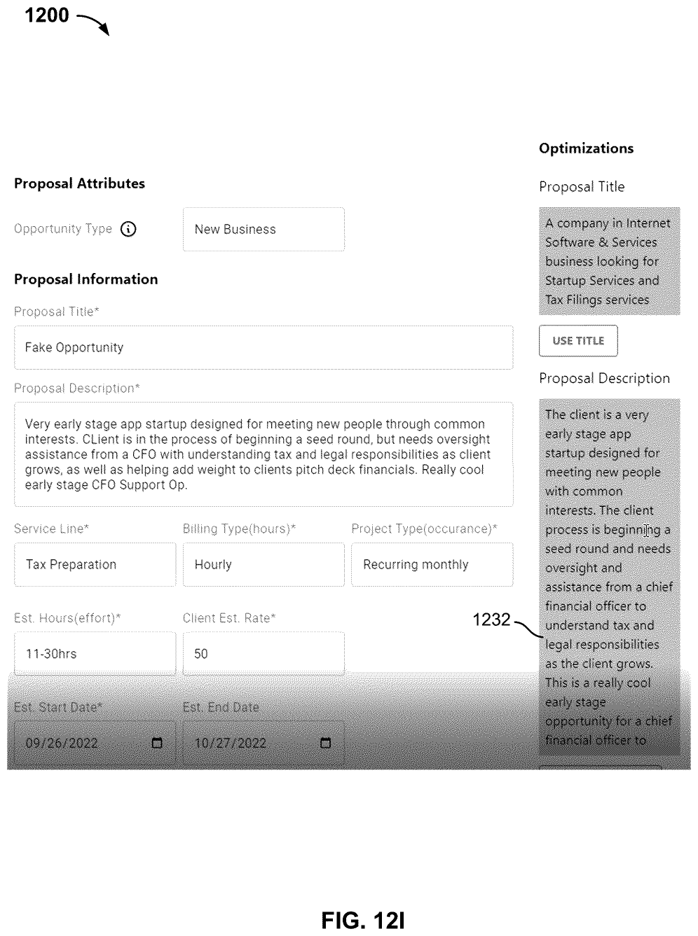

FIG. 12A is an example of an intake form for a specification of a desired service in accordance with some embodiments. In the example shown, the intake form 1200 includes a call notes section 1230 that provides a service provider with the ability to describe a service for which the matching engine needs to select a service provider candidate from a pool of service provider candidates. As seen in FIG. 12B, the intake form 1200 includes a title section 1202 and a description section 1204. A service provider may enter text into the title section 1202 and the description section 1204. In some scenarios, the text entered into the title section 1202 and/or the text entered into the 1204 is not optimized to match potential service provider candidates with a desired service associated with intake form 1200. Intake form 1200 includes optimize title button 1212 and optimize description button 1214. In response to a selection of title button 1212, the title may be optimized for the service provider based on a size of the service provider and the industry associated with the service provider. The title may be generated using GPT-3 (Generative Pre-trained Transformer 3) and a classifier. As seen in FIG. 12C, intake form 1200 includes a service provider size section 1222 and an industry section 1224. In response to a selection of the service provider size section 1222, as seen in FIG. 12D, intake form 1200 provides a drop down menu 1226. FIG. 12E illustrates an example of an optimized title 1228 that is based on a size of a service provider and an industry associated with the service provider. FIG. 12F illustrates an example of a service provider selecting a use title button 1228. In response to a selection of the use title button 1228, as seen in FIG. 12G, the original title included in title section 1202 is replaced with the optimized title that is generated by the matching engine.

FIG. 12H illustrates a selection of optimize description button 1214. In response to the selection, the matching engine generates an optimized proposal description 1232. The optimizes proposal description 1232 may be generated using GPT-3 and a classifier. The optimized proposal description 1232 may be based on the text included in the call notes section 1232 and/or the text included in the proposal description section 1204.

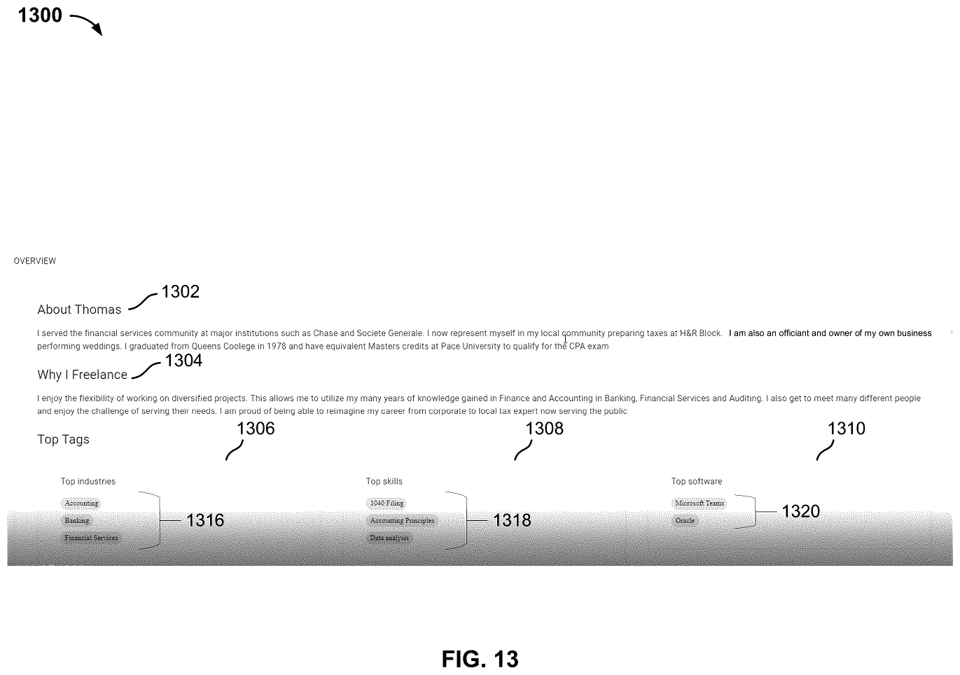

FIG. 13 is an example of a profile of a service provider candidate in accordance with some embodiments. In the example shown, profile 1300 includes an “About” section 1302 that allows the service provider candidate to describe themselves in text. Profile 1300 also includes a “Why I Freelance” section 1304 that allows the service provider candidate to describe in words why they freelance. Sections 1302 and 1304 may be utilized to generate an embedding for the service provider candidate. Other types of freeform text section (not shown) may also be used to generate the embedding for the service provider candidate.

Profile 1300 incudes an industry tag section 1306, a skills section 1308, and a software skills 1310. The service provider candidate may list in profile 1300, if applicable, the one or more tags associated each tag section. As seen in profile 1300, the service provider candidate has added industry tags 1316, skills tags 1318, and software tags 1320 to their profile.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method, comprising:
using machine learning to determine different relative component score weighting options for different service categories by training a plurality of machine learning models, wherein each of the plurality of machine learning models is associated with one of the different service categories and configured to output a corresponding total score that is based on a corresponding plurality of different component scores, wherein a relative component score weighting option of the different relative component score weighting options indicates a relative weighting between the corresponding different component scores, wherein using the machine learning includes determining that a corresponding relative weighting of a first component score of the plurality of different component scores for a first machine learning model associated with a first service category is different for a second machine learning model associated with a second service category, wherein the corresponding relative weighting of the first component score indicates a first total possible number of points allocated to the first component score for the first service category and a second total possible number of points allocated to the first component score for the second service category, wherein using the machine learning includes adjusting the corresponding relative weighting of the first component score for the first machine learning model associated with the first service category and the corresponding relative weighting of the first component score for the second machine learning model associated with the second service category from an initial equal weighting with respect to other different component scores to the determined corresponding relative weighting of the first component score for the first machine learning model associated with the first service category and the determined corresponding relative weighting of the first component score for the second machine learning model associated with the second service category;
receiving a specification of a desired service in a specific service category;
identifying, for the specific service category, a specific relative component score weighting among the different relative component score weighting options;
analyzing a profile of a service provider candidate using machine learning to determine at least one component score among a specific plurality of different component scores for the service provider candidate, wherein using machine learning to determine at least the one component score for the service provider candidate includes:
generating a first embedding for the specification of the desired service by applying one or more sentence transformers to a description portion of the specification of the desired service, wherein the one or more sentence transformers remove extraneous information from the specification of the desired service;
generating a second embedding for one or more text sections of the profile of the service provider candidates;
computing a similarity value between the first embedding and the second embedding;
scaling a number of points allocated to the first component score for the specific service category based on the computed similarity value, wherein the first service category is the specific service category; and
calculating a specific total score for the service provider candidate using the specific plurality of different component scores individually weighted based on the identified specific relative component score weighting for the specific service category, wherein the specific total score for the service provider candidate includes the scaled number of points allocated to the first component score.

2. The method of claim 1, wherein a supervised machine learning model is used to determine the different relative component score weighting options for the different service categories.

3. The method of claim 1, wherein using machine learning to determine the different relative component score weighting options for the different service categories includes allocating a first number of points to the first component score for the first service category and allocating a second number of points to the first component score for the specific service category.

4. The method of claim 3, wherein the first number of points is different than the second number of points.

5. The method of claim 1, wherein the specification of the desired service includes one or more text sections.

6. (canceled)

7. The method of claim 5, wherein the first embedding is based on the one or more text sections included in the specification of the desired service.

8. (canceled)

9. The method of claim 1, wherein the similarity value between the first embedding and the second embedding is a cosine similarity value.

10. The method of claim 1, further comprising filtering a set of potential service provider candidates from a plurality of service provider candidates available for all service categories.

11. The method of claim 10, wherein the service provider candidate is included in the set of potential service provider candidates.

12. The method of claim 11, further comprising selecting one or more service provider candidates from the set of potential service provider candidates to include in a list of potential service provider candidates.

13. The method of claim 12, wherein the list of potential service provider candidates includes at least one experienced service provider candidate and at least one new service provider candidate.

14. The method of claim 12, further comprising providing the list of potential service provider candidates to a service provider associated with the specification.

15. The method of claim 14, further comprising receiving feedback regarding the list of potential service provider candidates from the service provider associated with the specification.

16. The method of claim 15, further comprising updating the identified relative component score weighting for the specific service category based on the received feedback.

17. The method of claim 15, wherein the received feedback includes removing a potential service provider candidate from the list of potential service candidates.

18. The method of claim 15, wherein the received feedback includes an indication of positive feedback or an indication of negative feedback associated with a potential service provider candidate from the list of potential service candidates.

19. A system, comprising:
a processor configured to:
use machine learning to determine different relative component score weighting options for different service categories by training a plurality of machine learning models, wherein each of the plurality of machine learning models is associated with one of the different service categories and configured to output a corresponding total score that is based on a corresponding plurality of different component scores, wherein a relative component score weighting option of the different relative component score weighting options indicates a relative weighting between the corresponding different component scores, wherein using the machine learning includes determining that a corresponding relative weighting of a first component score of the plurality of different component scores for a first machine learning model associated with a first service category is different for a second machine learning model associated with a second service category, wherein the corresponding relative weighting of the first component score indicates a first total possible number of points allocated to the first component score for the first service category and a second total possible number of points allocated to the first component score for the second service category, wherein using machine learning includes adjusting the corresponding relative weighting of the first component score for the first machine learning model associated with the first service category and the corresponding relative weighting of the first component score for the second machine learning model associated with the second service category from an initial equal weighting with respect to other different component scores to the determined corresponding relative weighting of the first component score for the first machine learning model associated with the first service category and the determined corresponding relative weighting of the first component score for the second machine learning model associated with the second service category;
receive a specification of a desired service in a specific service category;
identify, for the specific service category, a specific relative component score weighting among the different relative component score weighting options;
analyze a profile of a service provider candidate using machine learning to determine at least one component score among a specific plurality of different component scores for the service provider candidate, wherein using machine learning to determine at least the one component score for the service provider candidate includes:
generating a first embedding for the specification of the desired service by applying one or more sentence transformers to a description portion of the specification of the desired service, wherein the one or more sentence transformers remove extraneous information from the specification of the desired service;
generating a second embedding for one or more text sections of the profile of the service provider candidates;
computing a similarity value between the first embedding and the second embedding; and
scaling a number of points allocated to the first component score for the specific service category based on the computed similarity value, wherein the first service category is the specific service category;
calculating a specific total score for the service provider candidate using the specific plurality of different component scores individually weighted based on the identified specific relative component score weighting for the specific service category, wherein the specific total score for the service provider candidate includes the scaled number of points allocated to the first component score; and
a memory coupled to the processor and configured to provide the processor with instructions.

20. A computer program product embodied in a non-transitory computer readable medium and comprising computer instructions for:
using machine learning to determine different relative component score weighting options for different service categories by training a plurality of machine learning models, wherein each of the plurality of machine learning models is associated with one of the different service categories and configured to output a corresponding total score that is based on a corresponding plurality of different component scores, wherein a relative component score weighting option of the different relative component score weighting options indicates a relative weighting between the corresponding different component scores, wherein using the machine learning includes determining that a corresponding relative weighting of a first component score of the plurality of different component scores for a first machine learning model associated with a first service category is different for a second machine learning model associated with a second service category, wherein the corresponding relative weighting of the first component score indicates a first total possible number of points allocated to the first component score for the first service category and a second total possible number of points allocated to the first component score for the second service category, wherein using the machine learning includes adjusting the corresponding relative weighting of the first component score for the first machine learning model associated with the first service category and the corresponding relative weighting of the first component score for the second machine learning model associated with the second service category from an initial equal weighting with respect to other different component scores to the determined corresponding relative weighting of the first component score for the first machine learning model associated with the first service category and the determined corresponding relative weighting of the first component score for the second machine learning model associated with the second service category;
receiving a specification of a desired service in a specific service category;
identifying, for the specific service category, a specific relative component score weighting among the different relative component score weighting options;
analyzing a profile of a service provider candidate using machine learning to determine at least one component score among a specific plurality of different component scores for the service provider candidate, wherein using machine learning to determine at least the one component score for the service provider candidate includes:
generating a first embedding for the specification of the desired service by applying one or more sentence transformers to a description portion of the specification of the desired service, wherein the one or more sentence transformers remove extraneous information from the specification of the desired service;
generating a second embedding for one or more text sections of the profile of the service provider candidates; and
computing a similarity value between the first embedding and the second embedding;
scaling a number of points allocated to the first component score for the specific service category based on the computed similarity value, wherein the first service category is the specific service category; and
calculating a specific total score for the service provider candidate using the specific plurality of different component scores individually weighted based on the identified specific relative component score weighting for the specific service category, wherein the specific total score for the service provider candidate includes the scaled number of points allocated to the first component score.
